(19) United States
(12) Patent Application Publication
(10) Pub. No.: US 2010/0280840 A1
(43) Pub. Date: Nov. 4, 2010

(54) DRUG INFORMATION PROCESSING DEVICE AND DRUG INFORMATION PROCESSING METHOD

(75) Inventors: Gakuho Fukushi, Tokyo (JP); Takuya Oshima, Chiba (JP)

Correspondence Address: K&L Gates LLP, P. O. BOX 1135, CHICAGO, IL, 60690, US

(73) Assignee: SONY CORPORATION, Tokyo (JP)

(21) Appl. No.: 12/769,719

(22) Filed: Apr. 29, 2010

(30) Foreign Application Priority Data
Apr. 30, 2009 (JP) P2009-111568
Apr. 26, 2010 (JP) P2010-100803

(51) Int. Cl. G06Q 50/00; G06Q 10/00; G06F 17/30

(52) U.S. Cl. 705/2; 707/802; 707/E17.044

(57) ABSTRACT

A drug information processing device includes: a connection unit connecting via a global network to a data center, in which prescription on prescriptions in hospitals and dispensing information on dispensing in pharmacies are stored as a database in a correlated manner; an acquisition unit acquiring a unique identification information; a sending unit sending prescription information or dispensing information to be correlated to the database in response to acquisition of the identification information with the identification information used as a requirement for accessing and registration in the global network; a receiving unit receiving the prescription and dispensing information with the identification information used as a requirement for accessing and retrieving from the global network; and a providing unit providing information based on the prescription information and the dispensing information received by the receiving unit.

### CROSS REFERENCES TO RELATED APPLICATIONS

The present application claims priority to Japanese Priority Patent Applications JP2009-111568 filed in the Japan Patent Office on Apr. 30, 2009 and JP2010-100803 filed in the Japan Patent Office on Apr. 26, 2010, the entire contents of which are hereby incorporated by reference.

### BACKGROUND

The present application relates to a drug information processing device and a drug information processing method which are useful for providing drug information between hospitals and pharmacies, for example.

In recent years, in medical practice, generic brand drug products (so-called generic drugs) have become available. A generic drug is a drug which is produced after expiration of the patent rights protection period of an original drug and which has the same pharmacological effect as the original drug.

The generic drug is cheaper than the original drug and thus can reduce the burden of medical costs on patients.

Generally, physicians have full knowledge of the pharmacological effects, indications, and the like of the original drug. However, in many cases, physicians do not have sufficient knowledge of newly produced generic drugs because of their huge numbers.

Therefore, when a physician is presented with a drug chart indicating that a generic drug had been prescribed to a patient in other hospitals, for example, the physician has to retrieve the original drug corresponding to the generic drug from a pharmacopeia, etc. so as to check the pharmacological effects, indications, and the like of the generic drug. However, such a retrieval process may take a lot of time.

In the related art, JP-A-2004-126894, for example, proposes a medicine determination support system in which when a user inputs a generic drug name, an original drug corresponding to the generic drug is retrieved from a drug database and displayed to the user.

### SUMMARY

However, in the medicine determination support system, whenever a generic drug is prescribed to a patient, the user has to retrieve the original drug corresponding to the generic drug. Such a retrieval process may take a lot of time and may not be said to be convenient.

It is therefore desirable to provide a drug information processing device and a drug information processing method capable of improving convenience.

A drug information processing device according to an embodiment includes a connection unit that connects via a global network to a data center, in which prescription information on prescriptions in hospitals and dispensing information on dispensing in pharmacies are stored as a database in a correlated manner; an acquisition unit that acquires a unique identification information; a sending unit that sends prescription information or dispensing information that is to be correlated to the database of the data center connected to the global network in response to acquisition of the identification information by the acquisition unit with the identification information used as a requirement for accessing and registration in the global network; a receiving unit that receives the prescription information and the dispensing information that are correlated to the database in response to acquisition of the identification information by the acquisition unit with the identification information used as a requirement for accessing and retrieving from the global network; and a providing unit that provides information based on the prescription information and the dispensing information received by the receiving unit.

A drug information processing method according to another embodiment includes the steps of connecting via a global network to a data center, in which prescription information on prescriptions in hospitals and dispensing information on dispensing in pharmacies are stored as a database in a correlated manner; acquiring a unique identification information; sending prescription information or dispensing information that is to be correlated to the database of the data center connected to the global network in response to acquisition of the identification information in the acquiring step with the identification information used as a requirement for accessing and registration in the global network; receiving the prescription information and the dispensing information that are correlated to the database in response to acquisition of the identification information in the acquiring step with the identification information used as a requirement for accessing and retrieving from the global network; and providing information based on the prescription information and the dispensing information received in the receiving step.

With this configuration, the prescription information and the dispensing information which is correlated to the identification information are acquired from the data center, and information based on the prescription information and the dispensing information can be provided. Therefore, it is possible to present easily the information based on the prescription information and the dispensing information to users.

According to the embodiments, the prescription information and the dispensing information which is correlated to the identification information are acquired from the data center, and information based on the prescription information and the dispensing information can be provided. Therefore, it is possible to realize a drug information processing device and a drug information processing method capable of presenting easily the information based on the prescription information and the dispensing information to users and thus improving convenience.

Additional features and advantages are described herein, and will be apparent from the following Detailed Description and the figures.

### BRIEF DESCRIPTION OF THE FIGURES

FIG. 1 is a schematic diagram showing a drug information processing system.

FIGS. 2A to 2C are schematic block diagrams showing configurations of databases stored in a data center.

FIG. 3 is a schematic diagram showing a configuration of a user database.

FIGS. 4A and 4B are schematic diagrams showing a configuration of a basic patient information database.

FIGS. 5A and 5B schematic diagrams showing configurations of a prescription history index table and a dispensing history index table.

FIGS. 6A and 6B are schematic diagrams showing configurations of a prescription history information table and a dispensing history information table.

FIGS. 7A to 7C are schematic diagrams showing configurations of tables stored in an intra-hospital database server.

FIGS. 8A to 8C are schematic diagrams showing configurations of tables stored in an intra-pharmacy database server.

FIG. 9 is a schematic diagram showing a circuit configuration of an intra-hospital client and an intra-pharmacy client.

FIG. 10 is a flowchart showing a procedure of an IC card registration process.

FIG. 11 is a flowchart showing a procedure of an electronic drug chart display process.

FIG. 12 is a schematic diagram showing an electronic drug chart display screen.

FIG. 13 is a flowchart showing a first procedure of a prescription information registration process.

FIG. 14 is a flowchart showing a second procedure of the prescription information registration process.

FIG. 15 is a flowchart showing a procedure of a prescription information recording process.

FIG. 16 is a flowchart showing a first procedure of a dispensing information generation process.

FIG. 17 is a flowchart showing a second procedure of the dispensing information generation process.

FIG. 18 is a schematic diagram showing a prescription information selection screen.

FIGS. 19A to 19D are schematic diagrams showing a dispensing drug selection screen.

FIG. 20 is a flowchart showing a procedure of a dispensing information registration process.

### DETAILED DESCRIPTION

The present application will be described below in reference to the drawings according to an embodiment. The description will be given in the following order.

1. Embodiment

2. Other Embodiments

### 1. Embodiment

### 1-1. Configuration of Drug Information Processing System

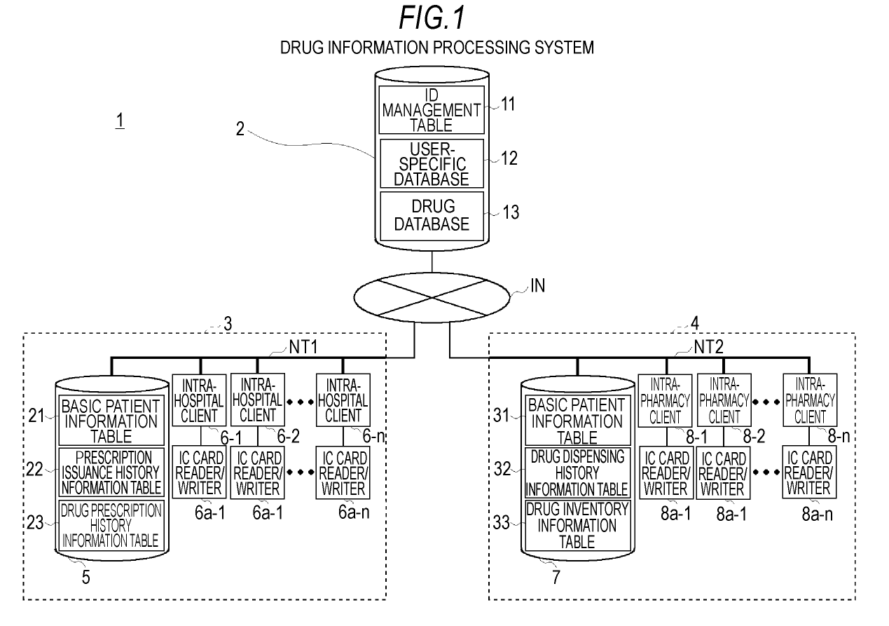

As shown in FIG. 1, a drug information processing system 1 includes a data center 2, an intra-hospital system 3, and an intra-pharmacy system 4. In the drug information processing system 1, the data center 2 is connected to the intra-hospital system 3 and the intra-pharmacy system 4 via the Internet IN which is a global network.

The data center 2 is a personal computer that includes, for example, a CPU (central processing unit), a RAM (random access memory) functioning as a work memory of the CPU, a ROM (read only memory) storing various programs, and the like.

The data center 2 operates based on control of the CPU, and an ID management table 11, a user-specific database 12, and a drug database 13 are stored in a storage unit which is an HDD (Hard Disk Drive), for example.

The intra-hospital system 3 includes an intra-hospital database server 5 and an intra-hospital clients 6 (6-1, 6-2, . . . , and 6-n) which serve as clients of the intra-hospital database server 5. In this intra-hospital system 3, the intra-hospital database server 5 is connected to the intra-hospital clients 6 via a dedicated local network NT1.

Moreover, in the intra-hospital system 3, the intra-hospital database server 5 and the intra-hospital clients 6 are connected to the data center 2 via the local network NT1 and the Internet IN.

The intra-hospital database server 5 is a personal computer that includes, for example, a CPU, a RAM, a ROM, a storage unit, and the like, and a basic patient information table 21, a prescription issuance history information table 22, and a drug prescription history information table 23 are stored in the storage unit.

The intra-hospital clients 6 (6-1, 6-2, . . . , and 6-n) are connected to IC (integrated circuit) card readers/writers 6a (6a-1, 6a-2, . . . , and 6a-n), respectively.

The intra-hospital client 6 is configured to be able to acquire a card ID (identifier) which is uniquely assigned to an IC card when a non-contact IC card, for example, is swiped through the IC card reader/writer 6a.

Moreover, the intra-hospital client 6 is configured to be able to read and update the basic patient information table 21, the prescription issuance history information table 22, and the drug prescription history information table 23 of the intra-hospital database server 5 via the local network NT1.

Furthermore, the intra-hospital client 6 is configured to be able to read and update the ID management table 11, the user-specific database 12, and the drug database 13 of the data center 2 via the local network NT1 and the Internet IN.

On the other hand, the intra-pharmacy system 4 includes an intra-pharmacy database server 7 and intra-pharmacy clients 8 (8-1, 8-2, . . . , and 8-n) functioning as clients of the intra-pharmacy database server 7. In the intra-pharmacy system 4, the intra-pharmacy database server 7 is connected to the intra-pharmacy clients 8 via a dedicated local network NT2.

Moreover, in the intra-pharmacy system 4, the intra-pharmacy database server 7 and the intra-pharmacy clients 8 are connected to the data center 2 via the Internet IN and the local network NT2.

The intra-pharmacy database server 7 is a personal computer that includes, for example, a CPU, a RAM, a ROM, a storage unit, and the like, and a basic patient information table 31, a drug dispensing history information table 32, and a drug inventory information table 33 are stored in the storage unit.

The intra-pharmacy clients 8 (8-1, 8-2, . . . , and 8-n) are connected to IC (integrated circuit) card readers/writers 8a (8a-1, 8a-2, . . . , and 8a-n). The intra-pharmacy client 8 is configured to be able to acquire a card ID which is uniquely assigned to an IC card when a non-contact IC card, for example, is swept through the IC card reader/writer 8a.

Moreover, the intra-pharmacy client 8 is configured to be able to read and update the basic patient information table 31, the drug dispensing history information table 32, and the drug inventory information table 33 of the intra-hospital database server 7 via the local network NT2.

Furthermore, the intra-pharmacy client 8 is configured to be able to read and update the ID management table 11, the user-specific database 12, and the drug database 13 of the data center 2 via the local network NT2 and the Internet IN.

### 1-2. Configuration of Database

1-2-1. Configuration of Database stored in Data Center 2

Next, the ID management table 11, the user-specific database 12, and the drug database 13 stored in the data center 2 will be described.

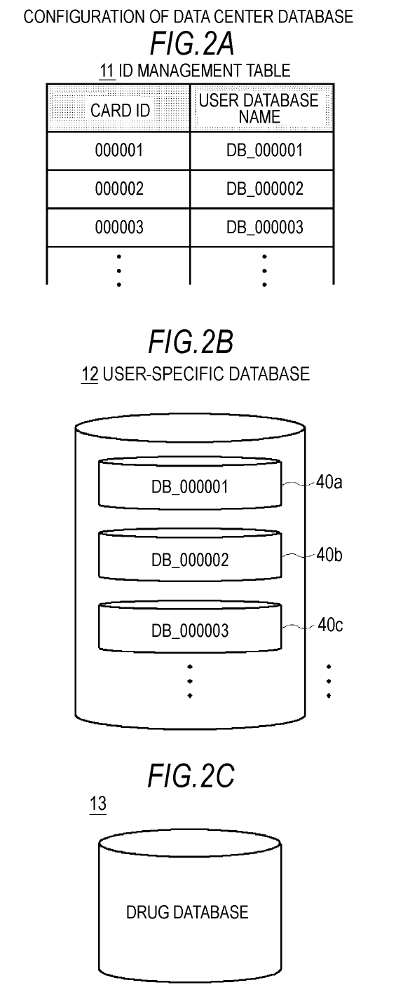

As shown in FIG. 2A, the ID management table 11 is a table that correlates card IDs of IC cards to user databases 40 (40a, 40b, etc.) as shown in FIG. 2B, provided to each patient in the user-specific database 12.

In the drug database 13 (FIG. 2C), a drug ID, a drug name, a drug ID of the corresponding original drug or generic drug, a drug price, a unit, and the like are described for each drug.

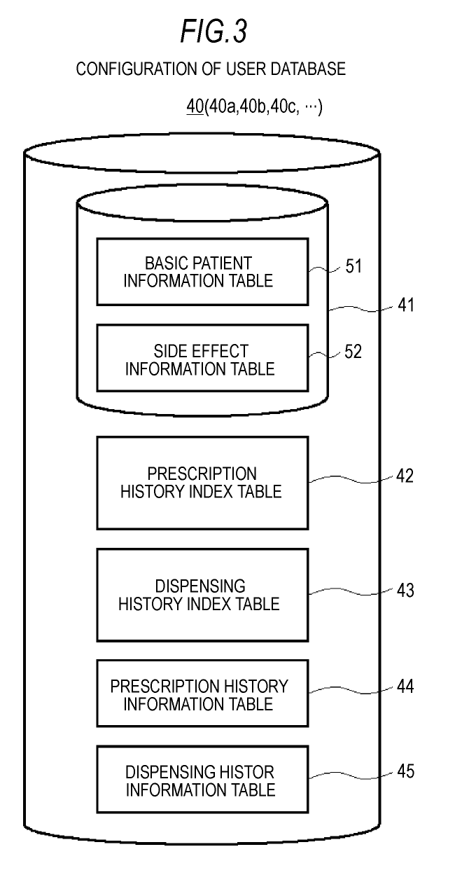

As shown in FIG. 3, in the user database 40 (40a, 40b, etc.), names are attached to the respective user databases described in the ID management table 11. In this user database 40, a basic patient information database 41, a prescription history index table 42, a dispensing history index table 43, a prescription history information table 44, and a dispensing history information table 45 are stored.

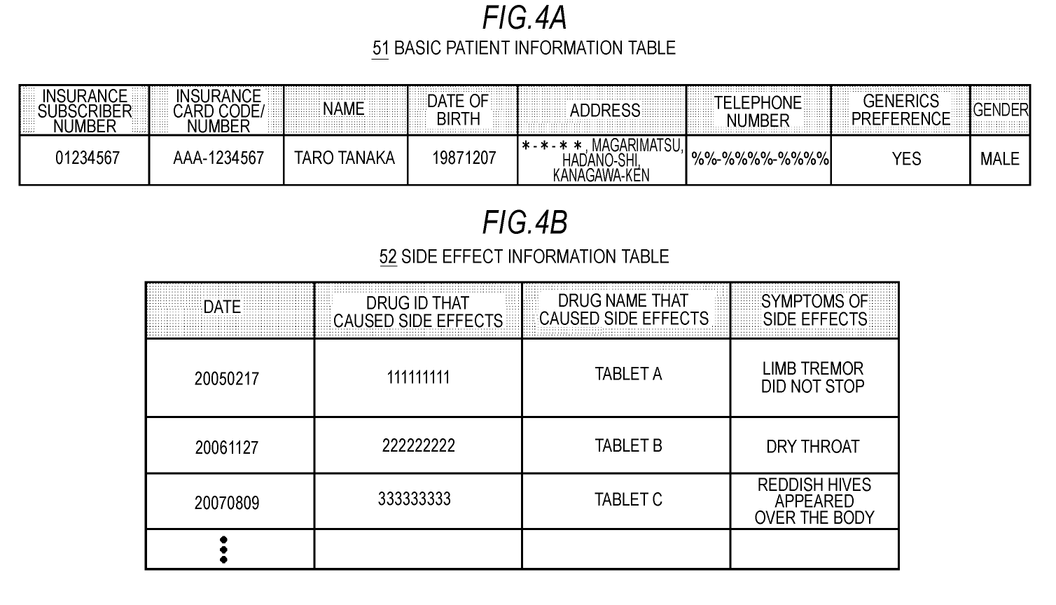

In the basic patient information database 41, a basic patient information table 51 and a side effect information table 52 shown in FIGS. 4A and 4B are stored.

In the basic patient information table 51 (FIG. 4A), personal information of a patient which is basic patient information and information as to whether or not the patient wants a generic drug are described. Here, the personal information is information for identifying patients and is an insurance subscriber number, an insurance card code/number, a patient name, a date of birth, an address, a telephone number, and a gender.

In the side effect information table 52 (FIG. 4B), the date of occurrence of side effects, the drug ID of the drug that causes the side effects, the drug name, and the symptoms of the side effects are described.

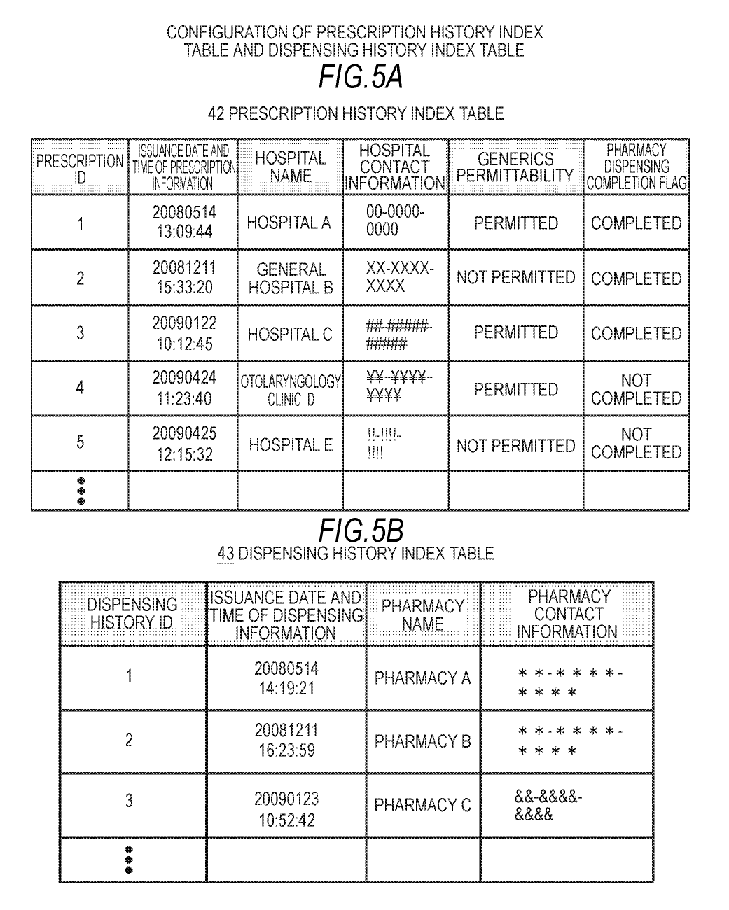

As shown in FIG. 5A, in the prescription history index table 42, prescription IDs are attached to prescription information, which is information on prescriptions in hospitals and issued by the intra-hospital client 6 described later, in ascending (oldest first) order of the issuance date and time, and basic information of the prescription information is described. Here, the basic information of the prescription information is the issuance date and time of the prescription information, the hospital name, the contact telephone number for the hospital, and information as to whether or not the use of generic drugs is permitted.

Moreover, in the prescription history index table 42, a pharmacy dispensing completion flag, which is enabled when the intra-pharmacy client 8 has completed the drug dispensing operation, is described.

As shown in FIG. 5B, in the dispensing history index table 43, dispensing history IDs with the same numbers as corresponding prescription IDs are attached to dispensing information, which is information on dispensing in pharmacies issued by the intra-pharmacy client 8, and basic information of the dispensing information is described. Here, the basic information of the dispensing information is an issuance date and time of the dispensing information, a pharmacy name, and a telephone number which is the pharmacy's contact information.

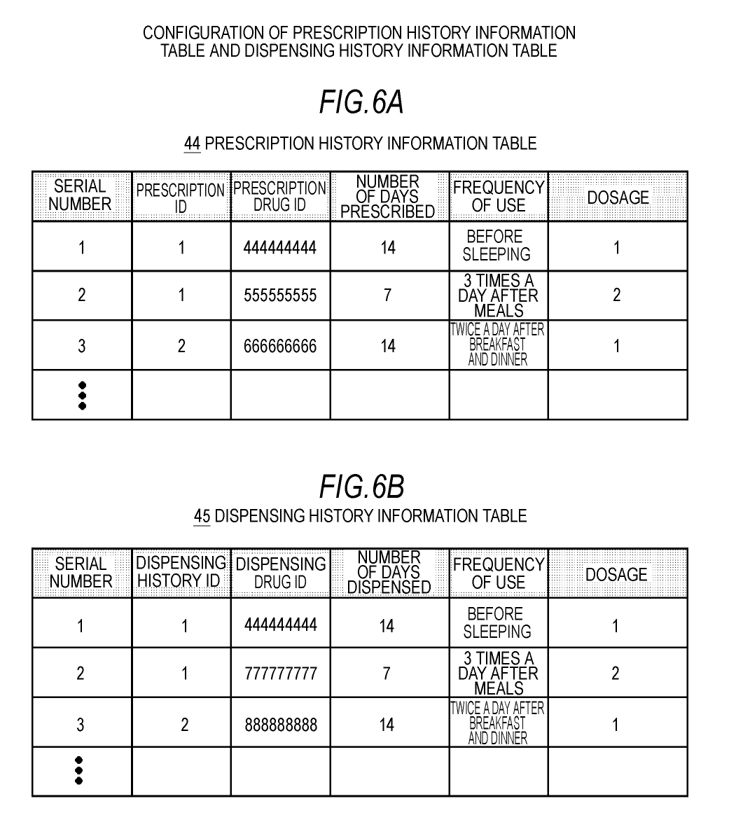

As shown in FIG. 6A, in the prescription history information table 44, serial numbers are attached to each drug, and the prescription ID of the corresponding prescription history index table 42 and detailed information of the prescription information issued by the intra-hospital client 6 described later are described. Here, the detailed information of the prescription information is a drug ID (prescription drug ID) of the prescribed drug, the number of days prescribed, the frequency of use, and the amount (dosage) of the drug that should be taken each time.

As shown in FIG. 6B, in the dispensing history information table 45, serial numbers are attached to each drug, and a dispensing history ID of the dispensing history index table 43 and detailed information of the dispensing information issued by the intra-pharmacy client 8 are described. Here, the detailed information of the dispensing information is a drug ID (dispensed drug ID) of the dispensed drug, the number of days prescribed, the frequency of use, and the amount (dosage) of the drug that should be taken each time.

### 1-2-2. Configuration of Database in Intra-Hospital Database Server

Next, the basic patient information table 21, the prescription issuance history information table 22, and the drug prescription history information table 23 stored in the intra-hospital database server 5 will be described.

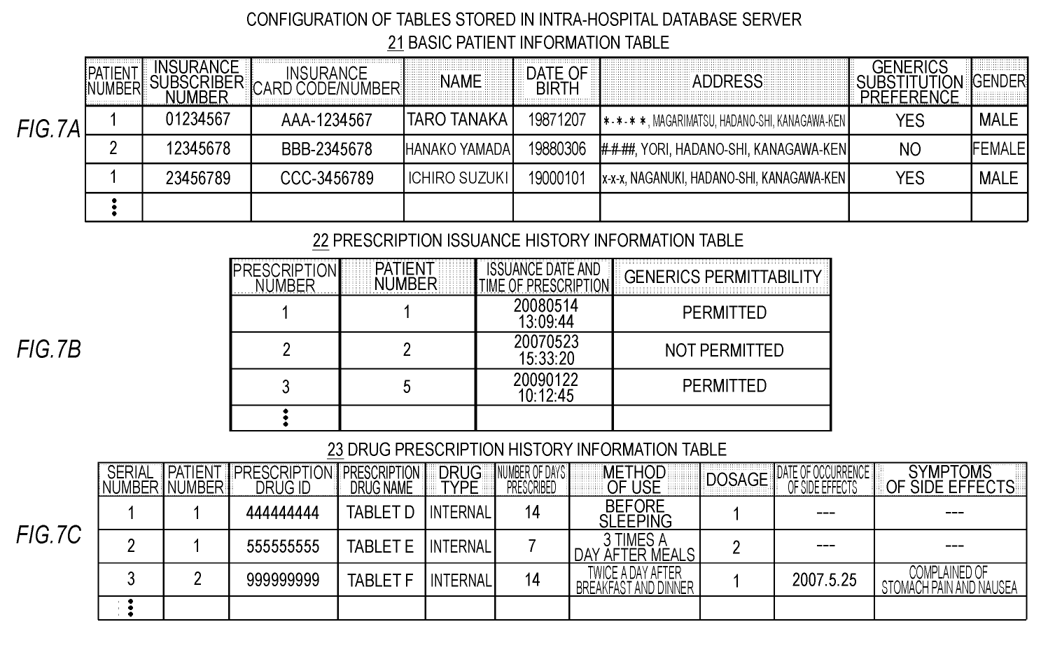

As shown in FIG. 7A, in the basic patient information table 21, patient numbers are attached to each patient, and personal information which is basic patient information for identifying patients in the intra-hospital system 3 and information as to whether or not the patient wants a generic drug are described.

As shown in FIG. 7B, in the prescription issuance history information table 22, prescription numbers are attached to the prescription information issued by the intra-hospital client 6, and the patient number in the basic patient information table 21 corresponding to the prescription information and basic information of the prescription information are described. Here, although the hospital name and hospital contact information are not described as basic information of the prescription information, the intra-hospital client 6 may attach the hospital name and the hospital contact information when sending the prescription information to the data center 2.

As shown in FIG. 7C, in the drug prescription history information table 23, serial numbers are attached to each drug in the prescription information issued by the intra-hospital client 6, and the prescription number corresponding to the prescription issuance history information table 22 is described.

Moreover, in the drug prescription history information table 23, the detailed information of the prescription information, which is a prescription drug ID, a prescription drug name, a drug type, the number of days prescribed, the frequency of use, and a dosage, and the side effect information, which is the date of occurrence of the side effects and the symptoms of side effects, are described. Moreover, the prescription drug name and the drug type may be omitted since they can be retrieved, for example, from the drug database 13 based on the prescription drug ID.

### 1-2-3. Configuration of Database in Intra-Pharmacy Database Server

Next, the basic patient information table 31, the drug dispensing history information table 32, and the drug inventory information table 33 stored in the intra-pharmacy database server 8 will be described.

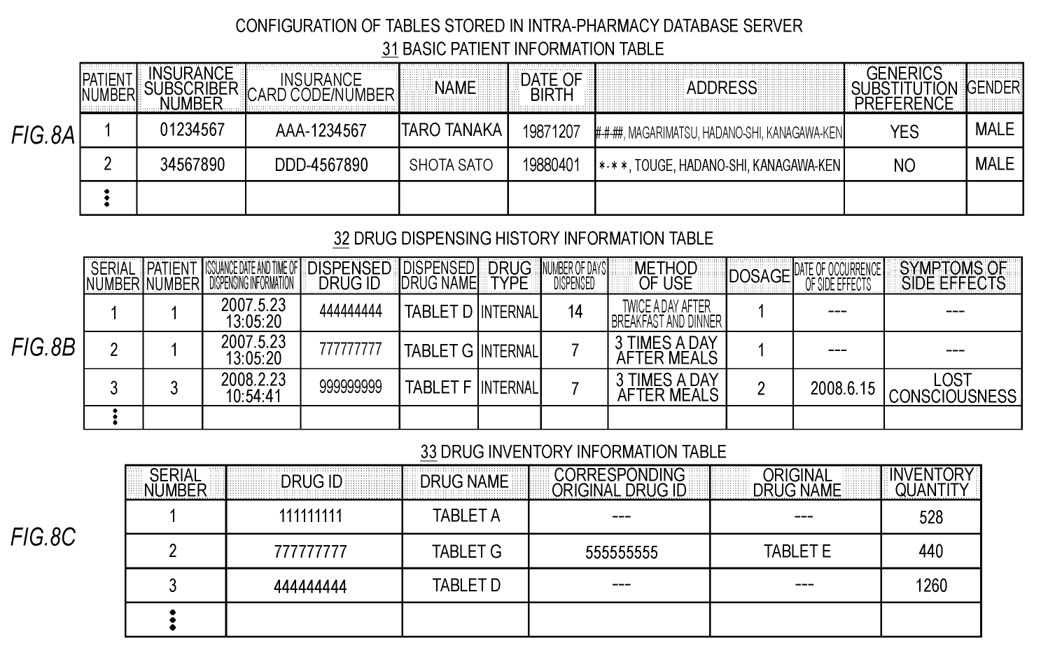

As shown in FIG. 8A, in the basic patient information table 31, patient numbers are attached to each patient, and personal information which is basic patient information for identifying patients in the intra-pharmacy system 4 and information as to whether or not the patient wants a generic drug are described.

As shown in FIG. 8B, in the drug dispensing history information table 32, serial numbers are attached to each dispensed drug in the dispensing information generated by the intra-pharmacy client 8, and the dispensing information and side effect information are described.

Although the pharmacy name and the pharmacy contact information are not described as the dispensing information, the intra-pharmacy client 8 may attach the pharmacy name and the pharmacy contact information when sending the dispensing information to the data center 2. Moreover, the dispensed drug name and the drug type may be omitted since they can be retrieved, for example, from the drug database 13 based on the dispensed drug ID.

As shown in FIG. 8C, in the drug inventory information table 33, serial numbers are attached to each drug, and the drug ID, drug name, and inventory quantity of that drug are described. When that drug is a generic drug, the drug ID, drug name, and inventory quantity of the corresponding original drug are described.

### 1-3. Circuit Configuration of Intra-Hospital Client and Intra-Pharmacy Client

### 1-3-1. Circuit Configuration of Intra-Hospital Client

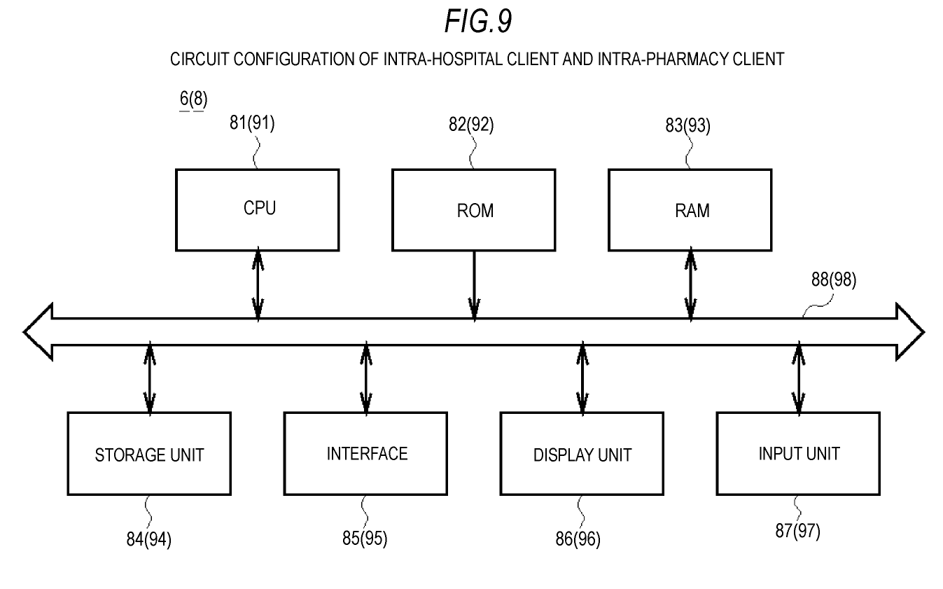

As shown in FIG. 9, the intra-hospital client 6 includes a CPU 81, a ROM 82, a RAM 83, a storage unit 84, an interface 85, a display unit 86, and an input unit 87.

The CPU 81 controls an overall operation in accordance with a basic program which is read out from the ROM 82 and run in the RAM 83. Moreover, the CPU 81 is configured to be able to execute various types of processes in accordance with various types of application programs which are read out from the ROM 82 and run in the RAM 83.

As the storage unit 84, a magnetic disk represented by an HDD, or a semiconductor memory, etc. are used. As the display unit 86, a liquid crystal display, an EL (Electro Luminescence) display, or a plasma display, etc. are used.

When an IC card is swiped through the IC card reader/writer 6a, the CPU 81 is able to acquire a card ID of the IC card via the IC card reader/writer 6a and the interface 85.

Moreover, the CPU 81 is configured to be able to receive the basic patient information, the prescription information, and the like from the intra-hospital database server 5 via the interface 85 and the local network NT1.

For example, when a patient has his/her first examination at a hospital with the intra-hospital system 3, the intra-hospital client 6 inputs basic patient information for identifying the patient via the input unit 87 and sends the input basic patient information to the intra-hospital database server 5.

At that time, the intra-hospital database server 5 attaches a new patient number to the basic patient information table 21 and stores the basic patient information sent thereto to be correlated to the patient number, thus updating the basic patient information table 21.

Moreover, the intra-hospital client 6 is configured to be able to read out the basic patient information in the basic patient information table 21 to change the preference to use substitute generic drugs, for example, from “NO” to “YES”.

Furthermore, the intra-hospital client 6 is configured such that, when a patient has experienced side effects to a prescribed drug, the intra-hospital client 6 is able to register the date and time of occurrence of side effects and the symptom of the side effects in the drug prescription history information table 23 with respect to the drug that caused the side effects.

Furthermore, as will be described later, the intra-hospital client 6 is configured to be able to receive the basic patient information, the prescription information, the dispensing information, and the like from the data center 2 via the interface 85, the local network NT1, and the Internet IN.

### 1-3-2. Circuit Configuration of Intra-Pharmacy Client

The intra-pharmacy client 8 has the same configuration as the intra-hospital client 6. A CPU 91 controls an overall operation in accordance with a basic program which is read out from a ROM 92 and run in a RAM 93. Moreover, the CPU 91 is configured to be able to execute various types of processes in accordance with various types of application programs which are read out from the ROM 92 and run in the RAM 93.

When an IC card is swiped through the IC card reader/writer 8a, the CPU 91 is able to acquire a card ID of the IC card via the IC card reader/writer 8a and the interface 95.

Moreover, the CPU 91 is configured to be able to receive the basic patient information, dispensing information, side effect information, and the like from the intra-pharmacy database server 7 via the interface 95 and the local network NT2.

Moreover, the intra-pharmacy client 8 is able to check the inventory of drugs by reading the drug inventory information table 33 from the intra-pharmacy database server 7 and displaying the drug inventory information table 33 on the display unit 97 in response to the operation of the input unit 97.

Furthermore, as will be described later, the intra-pharmacy client 8 is able to receive the basic patient information, prescription information, dispensing information, and the like from the data center 2 via the interface 95, the local network NT2, and the Internet IN.

### 1.4. Process in Intra-Hospital Client

Next, processes performed by the intra-hospital client 6 will be described.

### 1-4-1. IC Card Registration Process

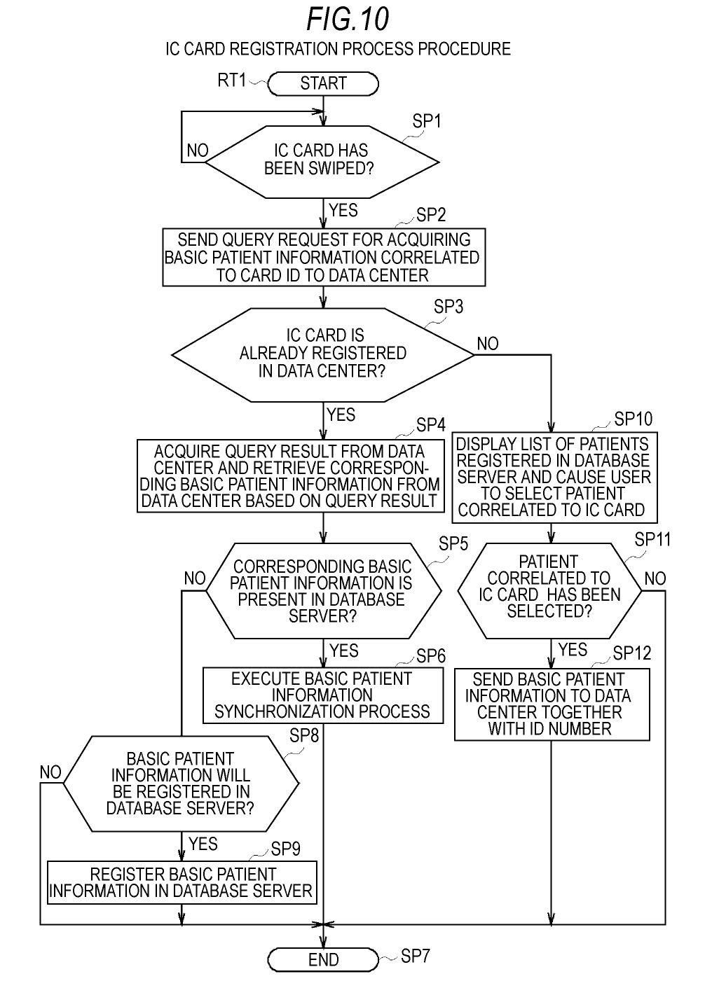

An IC card registration process for registering a card ID which is uniquely assigned to an IC card and basic patient information in the data center 2 in a correlated manner will be described with reference to the flowchart shown in FIG. 10.

In practice, the CPU 81 enters a starting step of routine RT1 and then proceeds to next step SP1. Then, the CPU 81 displays a message “Please swipe an IC card,” for example, on the display unit 86 and then determines whether or not an IC card is swiped through the IC card reader/writer 6a. If a negative result is obtained herein, the CPU 81 waits until an IC card is swiped through the IC card reader/writer 6a.

On the contrary, if an affirmative result is obtained in step SP1, this means that an IC card has been swiped through the IC card reader/writer 6a and a card ID acquired from the IC card. In this case, the CPU 81 proceeds to next step SP2.

In step SP2, based on the acquired card ID, the CPU 81 sends a query request for acquiring basic patient information correlated to the card ID to the data center 2 and then proceeds to next step SP3.

In this case, if the card ID in the query request is stored in the ID management table 11, the data center 2 determines that an IC card corresponding to the card ID is registered therein. Then, the data center 2 sends the basic patient information stored in the basic patient information table 51 and correlated to the card ID to the intra-hospital client 6 as a query result.

In step SP3, the CPU 81 determines whether or not the IC card is registered in the data center 2 based on whether or not the query result is sent from the data center 2. If an affirmative result is obtained herein, the CPU 81 proceeds to next step SP4.

In step SP4, based on the basic patient information obtained as the query result sent from the data center 2, the CPU 81 retrieves basic patient information of the same patient from the basic patient information table 21 of the intra-hospital database server 5 and then proceeds to next step SPS.

Specifically, the CPU 81 performs retrieval using any one of an insurance subscriber number, an insurance card code/number, and a patient name in the basic patient information sent from the data center 2 as a keyword. Then, the CPU 81 retrieves basic patient information that matches the keyword from the basic patient information table 21.

In step SP5, the CPU 81 determines whether or not the basic patient information retrieved in step SP4 is registered in the basic patient information table 21. If the basic patient information is registered therein, an affirmative result is obtained herein, and then the process proceeds to next step SP6.

In step SP6, the CPU 81 executes a basic patient information synchronization process, displays a message “This IC card is registered already”, for example, on the display unit 86, indicating that the IC card is registered already in the data center 2. Then, the process proceeds to next step SP7 and ends.

Here, the basic patient information synchronization process is a process of updating the basic patient information stored in the data center 2 and the basic patient information stored in the intra-hospital database server 5 to the one which is updated more recently based on the date and time of updating.

On the contrary, if a negative result is obtained in step SP5, this means that the basic patient information correlated to the IC card is not registered in the intra-hospital database server 5. In this case, the CPU 81 proceeds to step SP8.

In step SP8, the CPU 81 determines whether or not the basic patient information acquired from the data center 2 will be registered in the intra-hospital database server 5 based on an operation on the input unit 87. If a negative result is obtained herein, then the process proceeds to step SP7 and ends.

On the contrary, if an affirmative result is obtained in step SP8, the CPU 81 proceeds to step SP9 where the CPU 81 registers the basic patient information acquired from the data center 2 in the basic patient information table 21 of the intra-hospital database server 5. Then, the process proceeds to step SP7 and ends.

On the other hand, if a negative result is obtained in step SP3, this means that the IC card is not registered in the data center 2. In this case, the CPU 81 proceeds to step SP10.

In step SP10, the CPU 81 reads out patient names, for example, stored in the basic patient information table 21 of the intra-hospital database server 5, displays a list of the patient names on the display unit 86 so as to allow a user to select a patient correlated to the IC card, and then proceeds to next step SP11.

In step SP11, the CPU 81 determines whether or not a patient correlated to the IC card is selected. If a negative result is obtained herein, then the process proceeds to step SP7 and ends.

On the contrary, if an affirmative result is obtained in step SP11, this means that the patient correlated to the IC card is selected. In this case, the CPU 81 proceeds to next step SP12.

In step S12, the CPU 81 reads out basic patient information corresponding to the patient name selected in step SP10 from the basic patient information table 21 of the intra-hospital database server 5 and sends the basic patient information to the data center 2 together with the card ID.

In this way, the CPU 81 causes the basic patient information correlated to the card ID to be registered in the data center 2, and the process proceeds to step SP7 and ends.

As described above, in response to acquisition of the card ID, the intra-hospital client 6 registers the basic patient information in the data center 2 with the card ID used as the requirement for accessing and registration in the data center 2.

### 1-4-2. Electronic Drug Chart Display Process

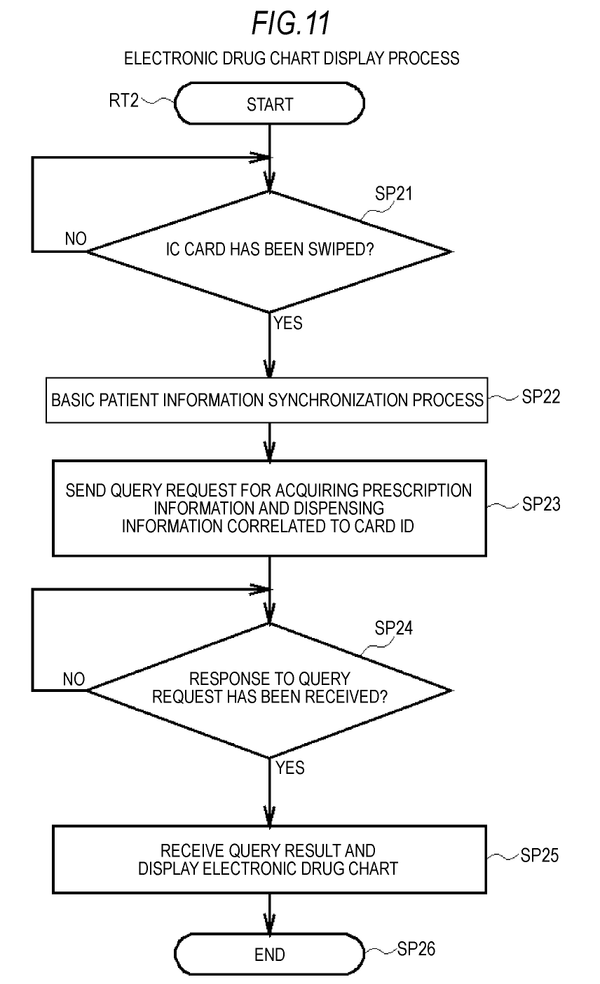

Next, an electronic drug chart display process for displaying drugs which are prescribed and dispensed to a patient for reference purposes will be described with reference to the flowchart shown in FIG. 11.

In practice, the CPU 81 enters a starting step of routine RT2 and then proceeds to next step SP21. Then, the CPU 81 displays a message “Please swipe the IC card,” for example, on the display unit 86 and then determines whether or not an IC card is swiped through the IC card reader/writer 6a. If a negative result is obtained herein, the CPU 81 waits until an IC card is swiped through the IC card reader/writer 6a.

On the contrary, if an affirmative result is obtained in step SP21, this means that an IC card has been swiped and the card ID is acquired from the IC card. In this case, the CPU 81 proceeds to next step SP22.

In step SP22, the CPU 81 executes the above-described basic patient information synchronization process to update the basic patient information table 21 of the data center 2 and the basic patient information table 51 of the intra-hospital database server 5 to the newest one and then proceeds to next step SP23.

In step SP23, based on the card ID acquired in step SP21, the CPU 81 sends a query request for acquiring prescription information and dispensing information correlated to the card ID to the data center 2 and then proceeds to next step SP24.

In this case, based on the query request sent from the intra-hospital client 6, the data center 2 reads out the prescription information and the dispensing information correlated to the card ID from the user database 40 and sends the prescription information and the dispensing information to the intra-hospital client 6 as a query result.

In step SP24, the CPU 81 displays a message “A response is being waited for,” for example, on the display unit 86 and then determines whether or not there is a response to the query request from the data center 2. If a negative result is obtained herein, the CPU 81 waits until a response to the query request is received.

On the contrary, if an affirmative result is obtained in step SP24, this means that there was a response to the query request from the data center 2. In this case, the CPU 81 proceeds to next step SP25.

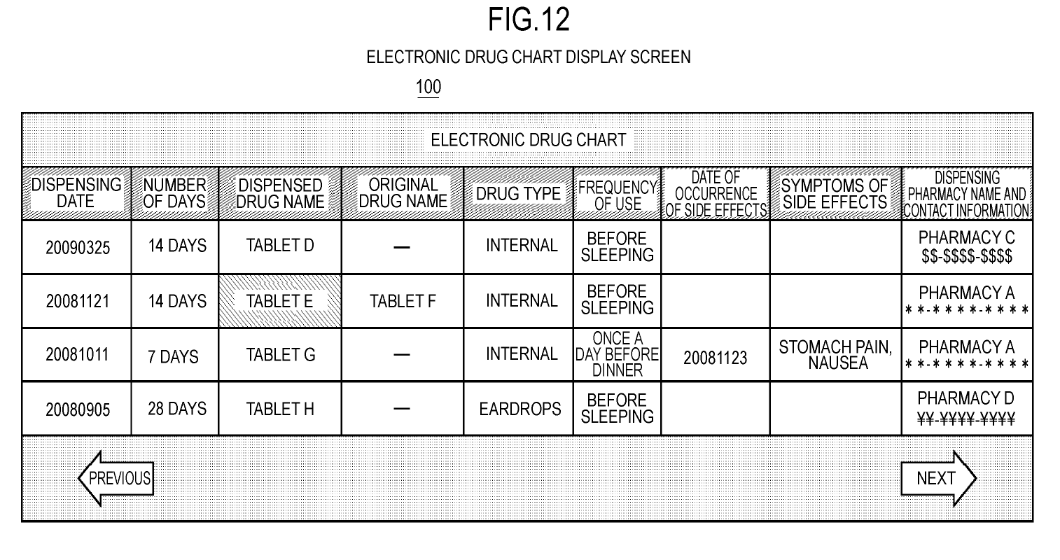

In step SP25, the CPU 81 acquires a query result from the data center 2 as a response to the query request. Then, based on the query result, the CPU 81 displays an electronic drug chart 100 on the display unit 86, representing dispensing information in a time-series manner as shown in FIG. 12. Then, the process proceeds to next step SP26 and ends.

Here, in the electronic drug chart 100, for example, the dispensing date and time, the number of days dispensed, the dispensed drug name, drug type, the frequency of use, quantity, and the dispensing pharmacy name and contact information.

In the electronic drug chart 100, the original drug name if the dispensed drug is a generic drug, and the date of occurrence of side effects and the symptoms of the side effects if side effects had occurred may also be displayed.

Moreover, if the dispensed drug is a generic drug, the dispensed drug name of that generic drug may be displayed in a different color or font on the electronic drug chart 100 so that the physician or patient can easily recognize the dispensed drug name.

Furthermore, the CPU 81 is configured such that, when a dispensed drug name is selected via the input unit 87, the CPU 81 is able to acquire detailed information on that dispensed drug name from the drug database 13 of the data center 2, for example, and display the acquired information on the display unit 86.

As described above, in response to acquisition of the card ID, the intra-hospital client 6 acquires the prescription information and the dispensing information from the data center 2 with the card ID used as the requirement for accessing and retrieving from the data center 2.

### 1-4-3. Prescription Information Registration Process

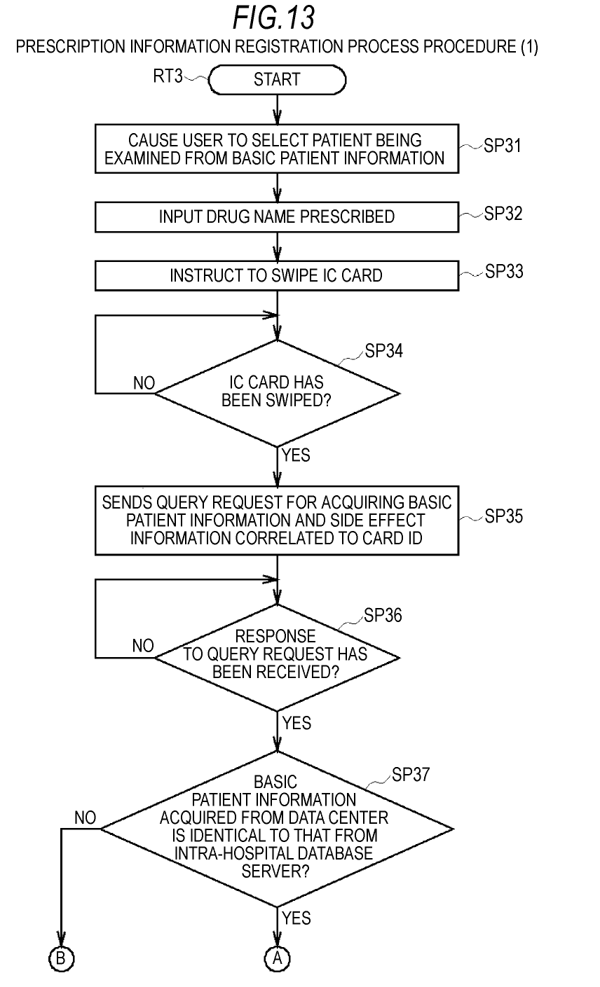

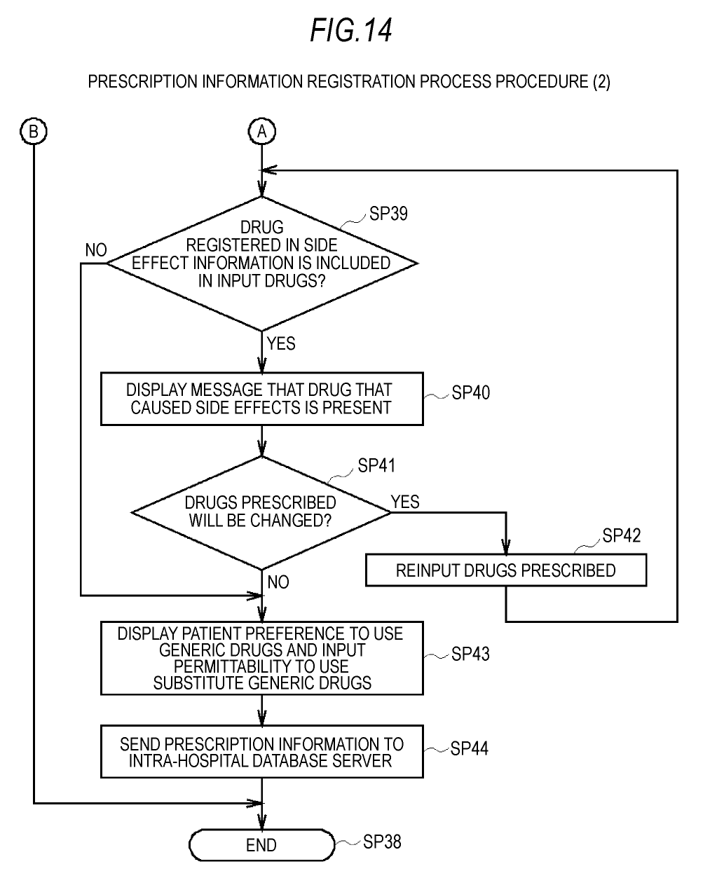

Next, a prescription information registration process for registering prescription information issued to a patient in the intra-hospital database server 5 will be described with reference to the flowcharts shown in FIGS. 13 and 14.

In practice, the CPU 81 enters a starting step of routine RT3 and then proceeds to next step SP31. Then, the CPU 81 reads out patient names, for example, from the basic patient information table 21 stored in the intra-hospital database server 5, displays a list of the patient names on the display unit 86 so as to allow the physician to select the patient being examined by the physician based on an operation on the input unit 87, and then proceeds to next step SP32.

In step SP32, the CPU 81 causes the physician to input drugs prescribed to the patient via the input unit 87 and then proceeds to next step SP33.

In step SP33, the CPU 81 displays a message “Please swipe an IC card,” for example, on the display unit 86 to instruct the physician or patient to swipe an IC card through the IC card reader/writer 6a and then proceeds to next step SP34.

In step SP34, the CPU 81 determines whether or not an IC card is swiped through the IC card reader/writer 6a at a predetermined time after the drugs are input in step SP31. If a negative result is obtained herein, the CPU 81 waits until an IC card is swiped through the IC card reader/writer 6a.

On the contrary, if an affirmative result is obtained in step SP34, this means that an IC card has been swiped and a card ID acquired from the IC card. In this case, the CPU 81 proceeds to next step SP35.

In step SP35, based on the card ID acquired in step SP34, the CPU 81 sends a query request for acquiring basic patient information and side effect information correlated to the card ID to the data center 2 and then proceeds to next step SP36.

In this case, in response to the query request, the data center 2 sends the basic patient information and the side effect information read out from the basic patient information table 51 and the side effect information table 52 and correlated to the card ID to the intra-hospital client 6 as a query result.

In step SP36, the CPU 81 determines whether or not there is a response to the query request from the data center 2. If a negative result is obtained herein, the CPU 81 waits until a response to the query request is received.

On the contrary, if an affirmative result is obtained in step SP36, this means that there was a response to the query request from the data center 2. In this case, the CPU 81 proceeds to next step SP37.

In step SP37, the CPU 81 acquires a query result from the data center 2 as a response to the query request. Then, the CPU 81 determines whether or not the basic patient information acquired as the query result is identical to the basic patient information of the patient selected in step SP31.

If a negative result is obtained herein, this means that the patient being examined by the physician is not identical to the patient correlated to the IC card. In this case, the CPU 81 displays a message “This IC card does not belong to the patient presently being examined,” for example, on the display unit 86, indicating that the patient being examined by the physician is not identical to the patient correlated to the IC card. Then, the process proceeds to next step SP38 and ends.

On the contrary, if an affirmative result is obtained in step SP37, the CPU 81 proceeds to step SP39. In step SP39, the CPU 81 determines whether or not a drug registered in the side effect information is included in the drugs input in step SP32.

If an affirmative result is obtained herein, this means that the drug that caused side effects for that patient is included in the drugs prescribed to the patient. In this case, the CPU 81 proceeds to next step SP40.

In step SP40, for example, when the physician has input tablet A which had caused side effects for the patient, the CPU 81 displays a message “Tablet A has caused side effects in the past,” for example, on the display unit 86. That is, the CPU 81 informs the physician of the fact that a drug that caused side effects is present, and then proceeds to next step SP41.

In step SP41, the CPU 81 determines whether or not the drugs prescribed to the patient will be changed based on an operation on the input unit 87. If an affirmative result is obtained herein, the CPU 81 proceeds to next step SP42.

In step SP42, the CPU 81 causes the physician to input the drug that is to be changed via the input unit 87 and returns to step SP39. Then, the operations in steps SP39 to SP42 are repeated until a negative result is obtained in step SP39 or SP41.

On the contrary, if a negative result is obtained in step SP39 or SP41, this means that the drugs prescribed to the patient are determined. In this case, the CPU 81 proceeds to step SP43.

In step SP43, the CPU 81 displays the preference to use generic drugs on the display unit 86 based on the preference to use generic drug in the basic patient information acquired in step SP37.

Then, the CPU 81 causes the physician to input information as to whether or not the physician permits the use of generic drugs as a substitute for the drugs prescribed to the patient via the input unit 86, and then proceeds to next step SP44.

In step SP44, the CPU 81 sends prescription information to the intra-hospital database server 5, showing the drugs input by the physician and information as to whether or not generic drugs will be used. In this way, the intra-hospital client 6 updates the prescription issuance history information table 22 and the drug prescription history information table 23 of the intra-hospital database server 5. Then, the process proceeds to next step SP38 and ends.

As described above, in response to acquisition of the card ID at a predetermined time after the prescription information is input, the intra-hospital client 6 sends the prescription information to the intra-hospital database server 5.

### 1-4-4. Prescription Information Recording Process

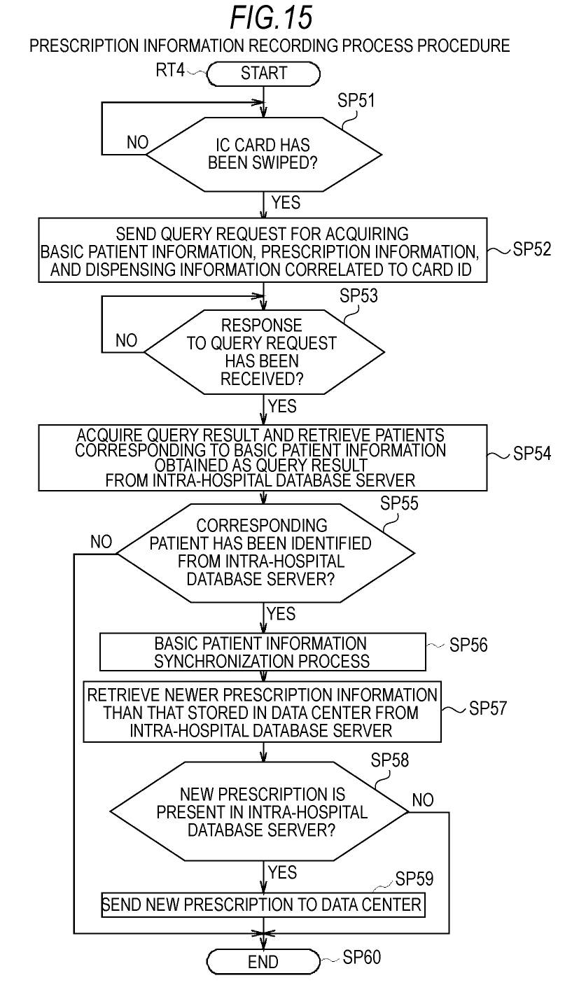

Next, a prescription information recording process for recording the prescription information recorded in the prescription issuance history information table 22 and the drug prescription history information table 23 of the intra-hospital database server 5 in the data center 2 will be described with reference to the flowchart shown in FIG. 15.

In practice, the CPU 81 enters a starting step of routine RT4 and then proceeds to next step SP51. Then, the CPU 81 displays a message “Please swipe an IC card,” for example, on the display unit 86 and then determines whether or not an IC card is swiped through the IC card reader/writer 6a. If a negative result is obtained herein, the CPU 81 waits until an IC card is swiped through the IC card reader/writer 6a.

On the contrary, if an affirmative result is obtained in step SP51, this means that an IC card has been swiped and a card ID acquired from the IC card. In this case, the CPU 81 proceeds to next step SP52.

In step SP52, based on the acquired card ID, the CPU 81 sends a query request for acquiring basic patient information, prescription information, and dispensing information correlated to the card ID to the data center 2 and then proceeds to next step SP53.

In this case, based on the query request sent from the intra-hospital client 6, the data center 2 reads out the basic patient information, the prescription information, and the dispensing information correlated to the card ID from the user database 40 and sends the basic patient information, the prescription information, and the dispensing information to the intra-hospital client 6 as a query result.

In step SP53, the CPU 81 displays a message “A response is being waited for,” for example, on the display unit 86 and then determines whether or not there is a response to the query request from the data center 2. If a negative result is obtained herein, the CPU 81 waits until a response to the query request is received.

On the contrary, if an affirmative result is obtained in step SP53, this means that there was a response to the query request from the data center 2. In this case, the CPU 81 proceeds to next step SP54.

In step SP54, the CPU 81 acquires a query result from the data center 2 as a response to the query request. Then, the CPU 81 retrieves patients corresponding to the basic patient information obtained as the query result from the basic patient information table 21 of the intra-hospital database server 5 and then proceeds to next step SP55.

In step SP55, the CPU 81 determines whether or not it was possible to identify the corresponding patients obtained in step SP54 from the basic patient information table 21 of the intra-hospital database server 5.

If a negative result is obtained herein, this means that the basic patient information of the corresponding patients is not present in the intra-hospital database server 5. In this case, the CPU 81 displays a message “No data was found for Mr/Mrs XX,” for example, on the display unit 86. Then, the process proceeds to step SP60 and ends.

On the contrary, if an affirmative result is obtained in step SP55, this means that the basic patient information of the corresponding patients is present in the intra-hospital database server 5. In this case, the CPU 81 proceeds to next step SP56.

In step SP56, the CPU 81 executes the above-described basic patient information synchronization process to update the basic patient information table 21 of the data center 2 and the basic patient information table 51 of the intra-hospital database server 5 to the newest one and then proceeds to next step SP57.

In step SP57, the CPU 81 reads out the prescription information that is correlated to the patient identified by the retrieval in step SP55 from the prescription issuance history information table 22 and the drug prescription history information table 23 of the intra-hospital database server 5.

Then, the CPU 81 compares the prescription information read out from the intra-hospital database server 5 with the prescription information acquired from the data center 2 in step SP55 and then proceeds to next step SP58.

In step SP58, based on a comparison result in step SP57, the CPU 81 determines whether or not the prescription information stored in the intra-hospital database server 5 includes the prescription information that is not stored in the data center 2.

If a negative result is obtained herein, this means that the prescription information that is not stored in the data center 2 is not present in the intra-hospital database server 5. In this case, the CPU 81 displays a message “There is no data to be recorded,” for example, on the display unit 86. Then, the CPU 81 proceeds to step SP60 and the process ends.

On the contrary, if an affirmative result is obtained in step SP58, this means that the prescription information that is not stored in the data center 2 is present in the intra-hospital database server 5. In this case, the CPU 81 proceeds to step SP59.

In step SP59, the CPU 81 sends the prescription information that is not stored in the data center 2 to the data center 2.

In this case, the data center 2 stores the prescription information sent from the intra-hospital client 6 in the prescription history index table 42 and the prescription history information table 44.

Then, the CPU 81 displays a message “Recording of an electronic prescription is completed,” for example, on the display unit 86, and the process proceeds to step SP60 and ends.

As described above, in response to acquisition of the card ID, the intra-hospital client 6 registers the card ID in the data center 2 with the prescription information used as the requirement for accessing and registration in the data center 2.

### 1-5. Process in Intra-Pharmacy Client

Next, processes performed by the intra-pharmacy client 8 will be described.

### 1-5-1. IC Card Registration Process

The CPU 91 of the intra-pharmacy client 8 also executes the IC card registration process (FIG. 10) for registering a card ID which is uniquely assigned to an IC card and basic patient information in the data center 2 in a correlated manner. However, since the process is the same as the process in the intra-hospital client 6, description thereof will be omitted.

It should be noted that the CPU 91 is configured to perform the operations in steps later than step SP3 using the basic patient information recorded in the basic patient information table 31 of the intra-pharmacy database server 7.

### 1-5-2. Electronic Drug Chart Display Process

The CPU 91 of the intra-pharmacy client 8 also executes the electronic drug chart display process (FIG. 11) for displaying drugs which are prescribed and dispensed to a patient for reference purposes. However, since the process is the same as the process in the intra-hospital client 6, description thereof will be omitted.

### 1-5-3. Dispensing Information Registration Process

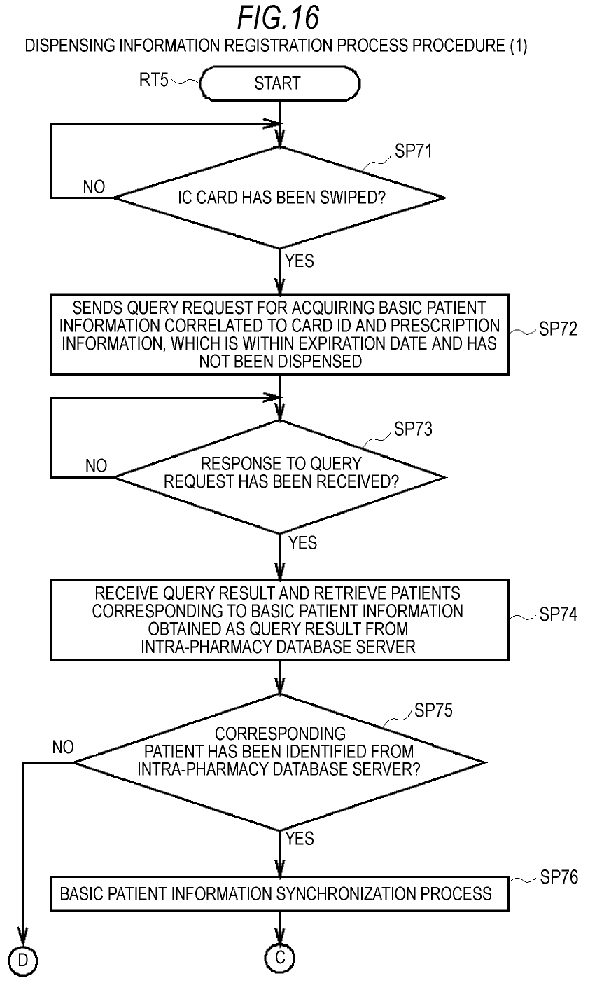

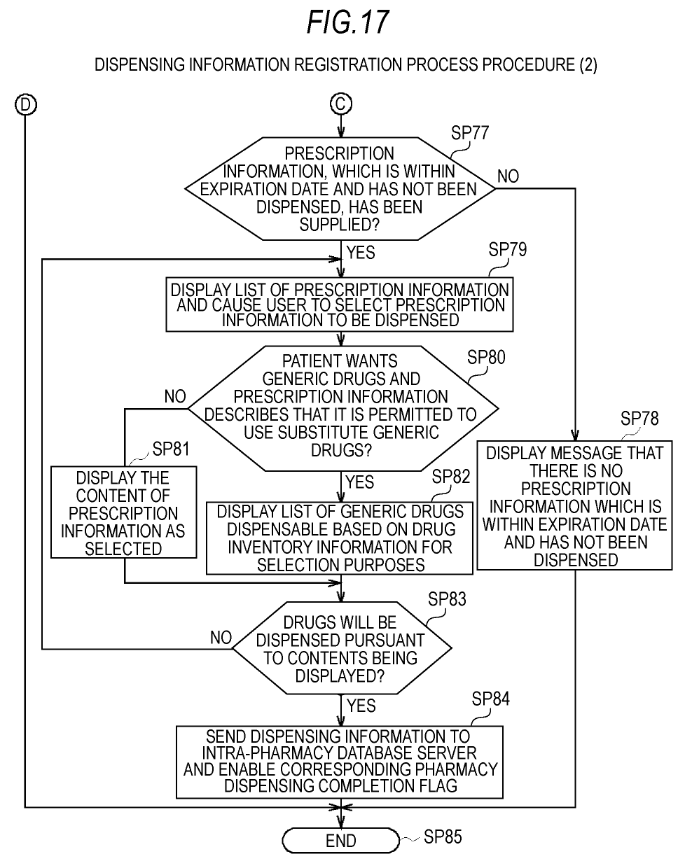

Next, a dispensing information registration process for registering drugs dispensed pursuant to the prescription information registered in the data center 2 in the intra-pharmacy database server 7 as dispensing information will be described with reference to the flowcharts shown in FIGS. 16 and 17.

In practice, the CPU 91 enters a starting step of routine RT5 and then proceeds to next step SP71. Then, the CPU 91 displays a message “Please swipe an IC card,” for example, on the display unit 96 and then determines whether or not an IC card is swiped through the IC card reader/writer 8a. If a negative result is obtained herein, the CPU 91 waits until an IC card is swiped through the IC card reader/writer 8a.

On the contrary, if an affirmative result is obtained in step SP71, this means that an IC card has been swiped and a card ID acquired from the IC card. In this case, the CPU 91 proceeds to next step SP72.

In step SP72, based on the acquired card ID, the CPU 91 sends a query request for acquiring basic patient information correlated to the card ID and prescription information, which is within an expiration date and has not yet been dispensed, to the data center 2 and then proceeds to next step SP73. Here, the expiration date is set to be 4 days, for example, from the prescription issuance date and time of the prescription information.

In this case, based on the query request sent from the intra-hospital client 6, the data center 2 reads out the basic patient information correlated to the card ID and the prescription information from the user database 40 and sends the basic patient information and the prescription information to the intra-pharmacy client 8 as a query result.

In step SP73, the CPU 91 displays a message “A response is being waited for,” for example, on the display unit 96 and then determines whether or not there is a response to the query request from the data center 2. If a negative result is obtained herein, the CPU 91 waits until a response to the query request is received.

On the contrary, if an affirmative result is obtained in step SP73, this means that there was a response to the query request from the data center 2. In this case, the CPU 91 proceeds to next step SP74.

In step SP74, the CPU 91 acquires a query result from the data center 2 as a response to the query request. Then, the CPU 91 retrieves patients corresponding to the basic patient information obtained as the query result from the basic patient information table 31 of the intra-pharmacy database server 7 and then proceeds to next step SP75.

In step SP75, the CPU 91 determines whether or not it was possible to identify the corresponding patients from the basic patient information table 31 of the intra-pharmacy database server 7.

If a negative result is obtained herein, this means that the prescription information of the corresponding patients is not present in the intra-pharmacy database server 7. In this case, the CPU 91 displays a message “No data was found for Mr/Mrs XX,” for example, on the display unit 96. Then, the process proceeds to step SP85 and ends.

On the contrary, if an affirmative result is obtained in step SP75, this means that the prescription information of the corresponding patients is present in the intra-pharmacy database server 7. In this case, the CPU 91 proceeds to next step SP76.

In step SP76, the CPU 91 executes the above-described basic patient information synchronization process to update the basic patient information table 51 of the data center 2 and the basic patient information table 31 of the intra-pharmacy database server 7 to the newest one and then proceeds to next step SP77 (FIG. 17).

In step SP77, based on the query result acquired in step SP74, the CPU 91 determines whether or not there is the prescription information which is within an expiration date and has not yet been dispensed. If a negative result is obtained herein, the CPU 91 proceeds to next step SP78.

In step SP78, the CPU 91 displays a message on the display unit 96, indicating that there is no prescription information which is within an expiration date and has not yet been dispensed. Then, the process proceeds to step SP85 and ends.

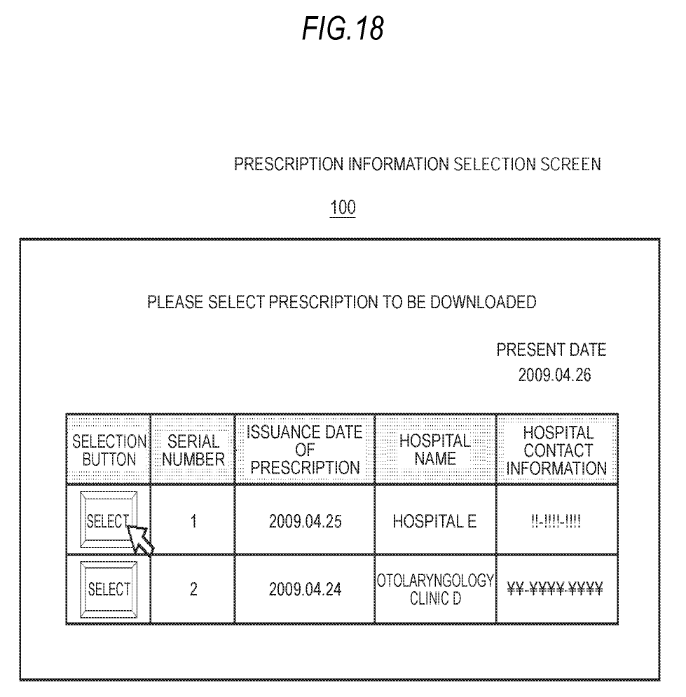

On the contrary, if an affirmative result is obtained in step SP77, the CPU 91 proceeds to step SP79. Then, the CPU 91 displays a prescription information selection screen 110 as shown in FIG. 18 on the display unit 96 and then proceeds to next step SP80.

In the prescription information selection screen 110, a prescription issuance date, a hospital name, and hospital contact information, which are examples of the prescription information within the expiration date and having not yet been dispensed, are displayed as a list in descending (newest first) order of the prescription issuance date and time. Moreover, selection buttons for selecting the prescription information to be dispensed are displayed.

In step SP80, when any one of the prescription information displayed in the prescription information selection screen 110 is selected, the CPU 91 determines whether or not the selected prescription information describes that it is permitted to use generic drugs as a substitute and whether or not the basic patient information describes that the patient wants generic drugs.

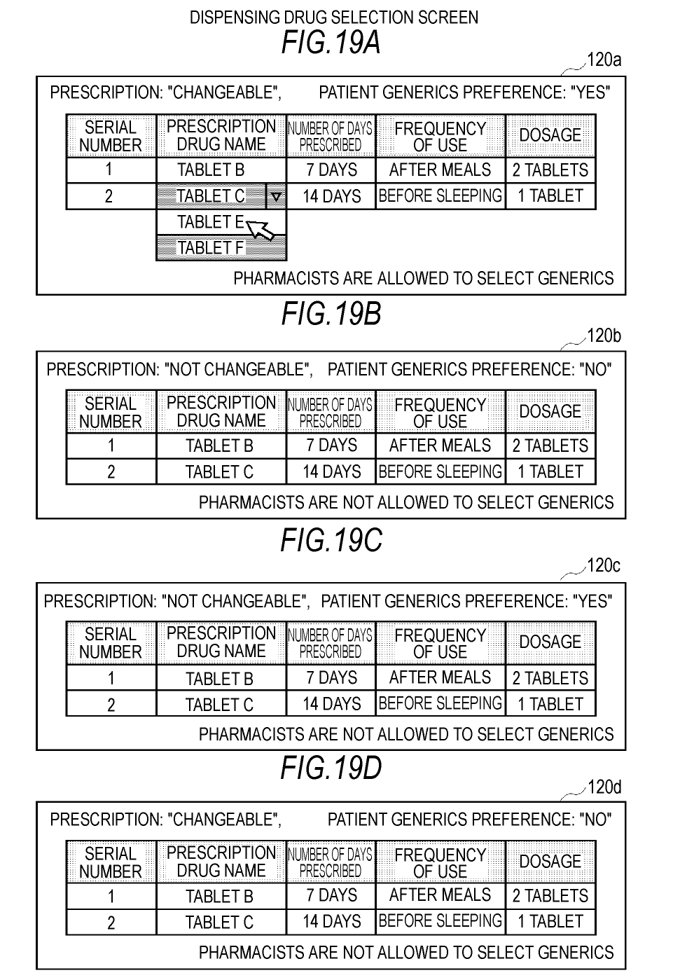

If an affirmative result is obtained herein, the CPU 91 proceeds to next step SP81 and displays a dispensing drug selection screen 120a on the display unit 96 as shown in FIG. 19A.

In this case, the CPU 91 reads out the drug inventory information table 33 from the intra-pharmacy database server 7. Then, when generic drugs that correspond to the drugs in the prescription information selected in step SP79 are present in the drug inventory information table 33, the CPU 91 displays a pull-down representation of the generic drugs in the dispensing drug selection screen 120a.

In this way, the CPU 91 causes the dispensing technician to select a generic drug available in the pharmacy and then proceeds to next step SP83.

On the contrary, if a negative result is obtained in step SP80, this means that the prescription information does not describe that it is permitted to use generic drugs as a substitute, and/or that the basic patient information does not describe that the patient wants generic drugs.

In this case, the CPU 91 proceeds to step SP82 and displays a dispensing drug selection screen 120b, 120c, or 120d shown in FIG. 19B, 19C, or 19D on the display unit 96, and then the process proceeds to next step SP83.

In step SP83, the CPU 91 determines whether or not drugs will be dispensed pursuant to the contents displayed in the dispensing drug selection screen 120a, 120b, 120c, or 120d based on an operation on the input unit 97.

If a negative result is obtained herein, the process returns to step SP79. Then, the operations in steps SP79 to SP83 are repeated until an affirmative result is obtained in step SP83.

On the contrary, if an affirmative result is obtained in step SP83, the CPU 91 proceeds to step SP84 and sends the contents displayed in the dispensing drug selection screen 110a, 110b, 110c, or 110d to the intra-pharmacy database server 7 as dispensing information.

In this case, the intra-pharmacy database server 7 updates the drug dispensing history information table 32 by registering the dispensing information therein.

Moreover, the CPU 91 enables a pharmacy dispensing completion flag corresponding to the dispensed prescription information in the prescription history index table 42 stored in the data center 2. Then, the process proceeds to step SP85 and ends.

### 1-5-4. Dispensing Information Recording Process

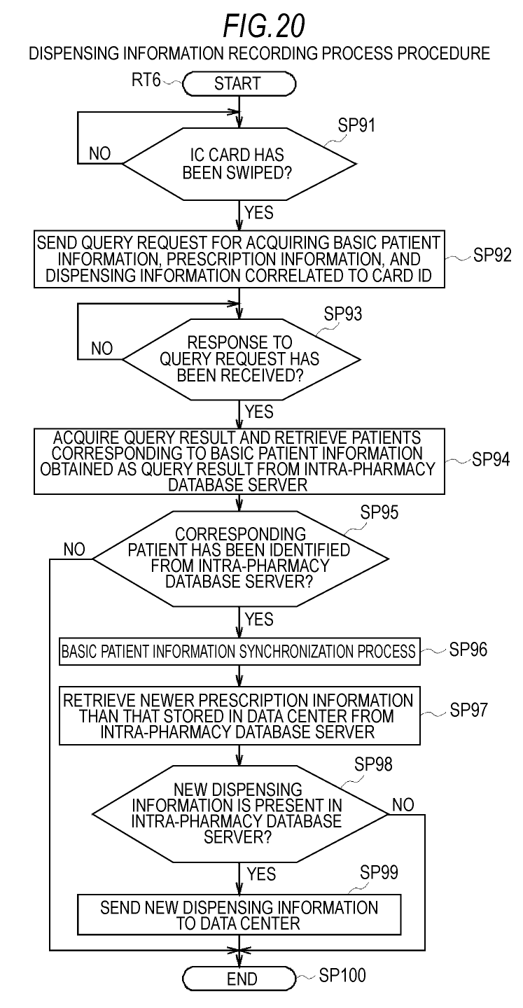

Next, a dispensing information recording process for recording the dispensing information recorded in the drug dispensing history information table 32 of the intra-pharmacy database server 7 in the data center 2 will be described with reference to FIG. 20.

In practice, the CPU 91 enters a starting step of routine RT6 and then proceeds to next step SP91. Then, the CPU 91 displays a message “Please swipe an IC card,” for example, on the display unit 96 and then determines whether or not an IC card is swiped through the IC card reader/writer 8a. If a negative result is obtained herein, the CPU 91 waits until an IC card is swiped through the IC card reader/writer 8a.

On the contrary, if an affirmative result is obtained in step SP91, this means that an IC card has been swiped and a card ID acquired from the IC card. In this case, the CPU 91 proceeds to next step SP92.

In step SP92, the CPU 91 sends a query request for acquiring basic patient information, prescription information, and dispensing information correlated to the card ID to the data center 2 and then proceeds to next step SP93.

In this case, based on the query request sent from the intra-pharmacy client 8, the data center 2 reads out the basic patient information, the prescription information, and the dispensing information correlated to the card ID from the user database 40 and sends the basic patient information, the prescription information, and the dispensing information to the intra-pharmacy client 8 as a query result.

In step SP93, the CPU 91 displays a message “A response is being waited for,” for example, on the display unit 96 and then determines whether or not there is a response to the query request from the data center 2. If a negative result is obtained herein, the CPU 91 waits until a response to the query request is received.

On the contrary, if an affirmative result is obtained in step SP93, this means that there was a response to the query request from the data center 2. In this case, the CPU 91 proceeds to next step SP94.

In step SP94, the CPU 91 acquires a query result from the data center 2 as a response to the query request. Then, the CPU 91 retrieves patients corresponding to the basic patient information obtained as the query result from the basic patient information table 31 of the intra-pharmacy database server 7 and then proceeds to next step SP95.

In step SP95, the CPU 91 determines whether or not it was possible to identify the corresponding patients obtained in step SP94 from the basic patient information table 31 of the intra-pharmacy database server 7.

If a negative result is obtained herein, this means that the basic patient information of the corresponding patients is not present in the intra-pharmacy database server 7. In this case, the CPU 91 displays a message “No data was found for Mr/Mrs XX,” for example, on the display unit 96. Then, the process proceeds to step SP100 and ends.

On the contrary, if an affirmative result is obtained in step SP95, this means that the basic patient information of the corresponding patients is present in the intra-pharmacy database server 7. In this case, the CPU 91 proceeds to next step SP96.

In step SP96, the CPU 91 executes the above-described basic patient information synchronization process to update the basic patient information table 51 of the data center 2 and the basic patient information table 31 of the intra-pharmacy database server 7 to the newest one and then proceeds to next step SP97.

In step SP97, the CPU 91 reads out the dispensing information that is correlated to the patient identified by the retrieval in step SP95 from the drug dispensing history information table 32 of the intra-pharmacy database server 7.

Then, the CPU 91 compares the dispensing information read out from the intra-pharmacy database server 7 with the dispensing information acquired in step SP94 and then proceeds to next step SP98.

In step SP98, the CPU 91 determines whether or not the dispensing information stored in the intra-pharmacy database server 7 includes the dispensing information that is not stored in the data center 2.

If a negative result is obtained herein, this means that the dispensing information that is not stored in the data center 2 is not present in the intra-pharmacy database server 7. In this case, the CPU 91 displays a message “There is no data to be recorded,” for example, on the display unit 96. Then, the CPU 91 proceeds to step SP100 and the process ends.

On the contrary, if an affirmative result is obtained in step SP98, this means that the dispensing information that is not stored in the data center 2 is present in the intra-pharmacy database server 7. In this case, the CPU 91 proceeds to step SP99.

In step SP99, the CPU 91 sends the dispensing information that is not stored in the data center 2 to the data center 2.

In this case, the data center 2 stores the dispensing information sent from the intra-pharmacy client 8 in the dispensing history index table 43 and the dispensing history information table 45.

Then, the CPU 91 displays a message “Recording of an electronic prescription is completed,” for example, on the display unit 96, and the process proceeds to step SP100 and ends.

### 1-6. Operation and Advantage

In the above-described configuration, the intra-hospital client 6 is connected via the local network NT1 to the intra-hospital database server 5 in which the prescription information is stored. Moreover, the intra-hospital client 6 is connected via the Internet IN, which is a global network, to the data center 2 in which the prescription information and the dispensing information is stored in a correlated manner.

The intra-hospital client 6 sends the prescription information to the data center 2 in response to acquisition of the card ID of an IC card via the IC card reader/writer 6a with the card ID used as the requirement for accessing and registration in the data center 2.

Moreover, the intra-hospital client 6 receives the prescription information and the dispensing information from the data center 2 in response to acquisition of the card ID of an IC card via the IC card reader/writer 6a with the card ID used as the requirement for accessing and retrieving from the data center 2.

Furthermore, the intra-hospital client 6 is configured to provide information on original drug names and the like corresponding to the generic drugs prescribed to patients, for example, based on the received prescription information and dispensing information by displaying as an electronic drug chart.

Therefore, the intra-hospital client 6 is able to provide the prescription information and the dispensing information, which are separately stored in the intra-hospital database server 5 and the intra-pharmacy database server 7, respectively, to physicians and patients in a correlated manner.

With this configuration, for example, the intra-hospital client 6 is able to provide drugs dispensed by pharmacies to physicians and to provide original drug names corresponding to generic drugs. Therefore, it is possible to reduce the time necessary for retrieving generic drugs.

Moreover, the intra-hospital client 6 is configured to allow storing an identification number assigned to a patient in a portable IC card so as to acquire a card ID, which is the identification number, from the IC card.

With this configuration, in the intra-hospital client 6, a patient or physician only needs to perform a simple operation of swiping an IC card through the IC card reader/writer 6a, for example, without needing to input an identification number via a keyboard or the like. Therefore, it is possible to improve usability of the intra-hospital client 6.

Moreover, the intra-hospital client 6 is configured to send the prescription information to the intra-hospital database server 5 in response to swiping of an IC card through the IC card reader/writer 6a at a predetermined time after a physician inputs drugs in the prescription information registration process.

With this configuration, it is unable to issue the prescription information by using any intra-hospital client 6, but the prescription information can be issued by using only the intra-hospital client 6 with which a physician is able to input drugs. Therefore, it is possible to improve security of the intra-hospital client 6.

According to the above-described configuration, the intra-hospital client 6 is configured to send the prescription information to the data center 2 or receive the prescription information and the dispensing information from the data center 2 in response to acquisition of the card ID of an IC card.

With this configuration, the intra-hospital client 6 is able to provide information based on the received prescription information and dispensing information and to thus improve convenience.

### 2. Other Embodiments

In the embodiment described above, a case where a card ID serving as identification information assigned to a patient is stored on an IC card, and a card ID acquired from the IC card has been described. However, the present application is not limited to this, and identification information may be stored in a portable storage medium such as a USB memory or a memory card so that the identification information is acquired from the storage medium. In addition, a patient himself/herself may be taken as a medium for example, and biometric information such as a fingerprint or vein information may be acquired by a predetermined biometric information reader as the identification information.

Moreover, in the above-described embodiment, a case where the side effect information table 52 is provided to the data center 2, and the side effect information is stored in the side effect information table 52 has been described. However, the present application is not limited to this, and the side effect information may be stored in the prescription history information table 44 or the dispensing history information table 45 together with the prescription information or the dispensing information.

Furthermore, in the above-described embodiment, a case where the basic patient information table 52 is provided to the data center 2, and information as to whether the patient wants generic drugs is stored in the basic patient information table 52 has been described. However, the present application is not limited to this, and the information as to whether or not a patient wants generic drugs may be stored and attached to the prescription information or the dispensing information of the prescription history information table 44 or the dispensing history information table 45.

Furthermore, in the above-described embodiment, a case where only one intra-hospital system 3 and only one intra-pharmacy system 4 are provided has been described. However, the present application is not limited to this, and plural intra-hospital systems 3 and plural intra-pharmacy systems 4 may be provided.

Furthermore, in the above-described embodiment, a case where the intra-hospital database server 5 and the intra-hospital client 6 in the intra-hospital system 3 are configured by different computers has been described. However, the present application is not limited to this, and the intra-hospital database server 5 and the intra-hospital client 6 may be configured by a same computer, that is an integrated system.

Furthermore, in the above-described embodiment, a case where the intra-pharmacy database server 7 and the intra-pharmacy client 8 in the intra-pharmacy system 4 are configured by different computers has been described. However, the present application is not limited to this, and the intra-pharmacy database server 7 and the intra-pharmacy client 8 may be configured by a same computer, that is an integrated system.

Furthermore, in the above-described embodiment, the case where the intra-hospital client 6 stores the generated prescription information in the intra-hospital database server 5 and sends the prescription information stored in the intra-hospital database server 5 to the data center 2 has been described. However, the present application is not limited to this, and the intra-hospital client 6 may send the generated prescription information to the data center 2 without via the intra-hospital database server 5. That is, the intra-hospital client 6 may send/receive various types of information to/from the data center 2 without via the intra-hospital database server 5.

Furthermore, in the above-described embodiment, the case where the intra-pharmacy client 8 stores the generated dispensing information in the intra-pharmacy database server 7 and sends the dispensing information stored in the intra-pharmacy database server 7 to the data center 2 has been described. However, the present application is not limited to this, and the intra-pharmacy client 8 may send the generated dispensing information to the data center 2 without via the intra-pharmacy database server 7. That is, the intra-pharmacy client 8 may send/receive various types of information to/from the data center 2 without via the intra-pharmacy database server 7.

Furthermore, in the above-described embodiment, a case where the CPUs 81 and 91 performs the above-described various types of processes in accordance with the programs stored in the ROMs 83 and 93 has been described. However, the present application is not limited to this, and the above-described various types of processes may be performed in accordance with a program which is installed from a storage medium or downloaded from the Internet. Moreover, the above-described various types of processes may be performed in accordance with a program which is installed along various other routes.

Furthermore, in the above-described embodiment, a case where the interface 86 is provided as a connection unit and an acquisition unit and the CPU 81 is provided as a sending unit, a receiving unit, and a providing unit. However, the present application is not limited to this, and a connection unit, an acquisition unit, a sending unit, a receiving unit, and a providing unit having various other configurations may be provided.

It should be understood that various changes and modifications to the presently preferred embodiments described herein will be apparent to those skilled in the art. Such changes and modifications can be made without departing from the spirit and scope and without diminishing its intended advantages. It is therefore intended that such changes and modifications be covered by the appended claims.

1. A drug information processing device comprising:
a connection unit that connects via a global network to a data center, in which prescription information on prescriptions in hospitals and dispensing information on dispensing in pharmacies are stored as a database in a correlated manner;
an acquisition unit that acquires a unique identification information;
a sending unit that sends prescription information or dispensing information that is to be correlated to the database of the data center connected to the global network in response to acquisition of the identification information by the acquisition unit with the identification information used as a requirement for accessing and registration in the global network;
a receiving unit that receives the prescription information and the dispensing information that is correlated to the database in response to acquisition of the identification information by the acquisition unit with the identification information used as a requirement for accessing and retrieving from the global network; and
a providing unit that provides information based on the prescription information and the dispensing information received by the receiving unit.

2. The drug information processing device according to claim 1, wherein the acquisition unit acquires the identification information from a portable storage medium.

3. The drug information processing device according to claim 2, wherein the sending unit sends the prescription information to the data center in response to acquisition of the identification information by the acquisition unit at a predetermined time after the prescription information is input via a predetermined input unit.

4. The drug information processing device according to claim 2,
wherein the prescription information includes intention information that represents the individual intentions of both a physician and a patient, and
wherein the providing unit provides all selection choices correlated to a predetermined selection candidate based on the prescription information and the dispensing information when the intention information pieces are identical.

5. A drug information processing method comprising the steps of:
connecting via a global network to a data center, in which prescription information on prescriptions in hospitals and dispensing information on dispensing in pharmacies are stored as a database in a correlated manner;
acquiring a unique identification information;
sending prescription information or dispensing information that is to be correlated to the database of the data center connected to the global network in response to acquisition of the identification information in the acquiring step with the identification information used as a requirement for accessing and registration in the global network;
receiving the prescription information and the dispensing information that is correlated to the database in response to acquisition of the identification information in the acquiring step with the identification information used as a requirement for accessing and retrieving from the global network; and
providing information based on the prescription information and the dispensing information received in the receiving step.
